(19) United States
(12) Patent Application Publication
(10) Pub. No.: US 2026/0097338 A1
(43) Pub. Date: Apr. 9, 2026

(54) PORTABLE MICROPLASTIC FILTER STAND

(71) Applicants: Brian P. Felker, Blandon, PA (US); Jill M. Felker, Blandon, PA (US); Abigail M. Felker, Blandon, PA (US); Joshua S. Felker, Blandon, PA (US)

(72) Inventors: Brian P. Felker, Blandon, PA (US); Jill M. Felker, Blandon, PA (US); Abigail M. Felker, Blandon, PA (US); Joshua S. Felker, Blandon, PA (US)

(21) Appl. No.: 18/911,184

(22) Filed: Oct. 9, 2024

(51) Int. Cl. B01D 35/34; C02F 1/00; C02F 101/30; F16M 11/22

(52) U.S. Cl. CPC B01D 35/34; C02F 1/003; F16M 11/22; C02F 2101/30

(57) ABSTRACT

A supporting device for the separation of microplastics from an outdoor water source. This device separates into portable components able to be transported. This device comprises a structural system that can freely stand in the water source and provide an elevated surface to secure a micron filter above the surface of the outdoor water source. The water from the water source is manually collected and poured through the top of the device. The microplastics in the poured water are removed by the secured micron filter, and the water passes through the device to return to the outdoor water source by gravity. The source of separated microplastics is derived from plastic material so the device is comprised of all metal material so that additional microplastic sources are not introduced during use.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD

The present invention relates to the separation of microplastic particles from water used during scientific research on microplastics in water. The disclosure belongs to the technical field of environmental ecology and academic research, which aims to identify and separate microplastics in outdoor water sources.

### BACKGROUND

Plastic waste products have become an unwanted burden with increased plastic development and manufacturing. Plastic pollution has become an emerging contaminant in freshwater environments, threatening water quality and human health. Once plastic waste enters an aquatic environment, degradation is slow unless exposed to waves or sunlight. As defined by the United States Environmental Protection Agency's Microplastic Beach Protocol in 2021, small plastic pieces less than 5 millimeters in size are known as microplastics. Microplastic pollution comprises various materials, sizes, and shapes and is challenging to differentiate from naturally occurring organic materials. Microplastics are mistaken for food and can bioaccumulate in aquatic organisms and disrupt ecosystem food webs. Understanding the amount of microplastics in an environment is essential to determine if mitigation efforts are needed.

There is a problem with filtering microplastics in the environment. Microplastic research in freshwater environments is limited due to the currently available filter devices. Large volumes of water must be filtered onsite at the surface water collection areas, which is often in remote natural environments. In addition, care must be taken to minimize habitat destruction and reduce additional anthropogenic influences on the environment. Current microplastic filter devices are comprised of plastic, rubber, or wood and can potentially trap collected microplastic material or contribute microplastic material through, which adds to contaminating microplastic enumeration and identification in research studies. Ideally, a lightweight, portable metal device should be used for environmental microplastic research studies. Using equipment near an outdoor water source poses additional problems for scientists so that they do not lose equipment or affect the microplastic filtering by touching the water source in an uncontrolled manner. There are no current solutions available to address these problems.

### SUMMARY

The portable microplastic filter stand is generally described as a piece of equipment to aid environmental research scientists in studying and understanding microplastics found in shallow water sources. The device can be separated into two main parts: a top table platform surface and a bottom post and legs. Separating these components provides portability for a scientist to transport this equipment more compactly compared to fully assembled. The portable microplastic filter stand is used in addition to common equipment that is used to filter water and materials like a micron filter or mesh sieve. A micron filter or mesh sieve provides a known opening size to trap microplastics as water and material pass through. A micron filter or mesh sieve is placed on top of the raised surface of the portable microplastic filter stand so that it is oriented level on a flat and porous surface. This top surface is elevated through the design of the portable microplastic filter stand so that it is above the waterline when used in outdoor water sources. Water and material are poured through the micron filter or mesh sieve, and the water and unfiltered material pass through the portable microplastic filter stand. The water and unfiltered material fall by gravity. The water and unfiltered material can pass through the micron filter or mesh sieve so that water flow is not hindered by the portable microplastic filter stand. The portable microplastic filter stand is only meant to stabilize and hold the micron filter or mesh sieve while being used. The portable microplastic filter stand allows environmental research scientists to take the portable microplastic filter stand into water locations outside or use it indoors. While using the device, the sampled water is returned immediately to the water source, where it is taken so that unneeded water removal does not occur.

### BRIEF DESCRIPTION OF THE DRAWING

The supporting drawings cited herein clarify the present disclosure, constitute a part of the present disclosure, and are not intended to limit the scope of the present disclosure.

FIG. 1 is an isometric view of the device fully assembled and a view shown without a micron filter or mesh sieve.

FIG. 2 is an isometric view of the device showing the separation of parts 1 Top and 2 Bottom, which makes it portable, and the view is shown without a micron filter or mesh sieve.

FIG. 3A is an isometric view of the device fully assembled with a micron filter identified before being placed on the device's elevated flat surface for use.

FIG. 3B is an isometric view of the device fully assembled with a micron filter (10) identified and placed on the device's elevated flat surface for use.

FIG. 4 is an isometric view of the device fully assembled with a micron filter identified and placed on the device's elevated flat surface for use. Water is poured through the micron filter through the device, illustrating an unrestricted flow rate. This view also illustrates the relative size of the device and its portability.

FIG. 5 is a top view of the device fully assembled without a micron filter or mesh sieve.

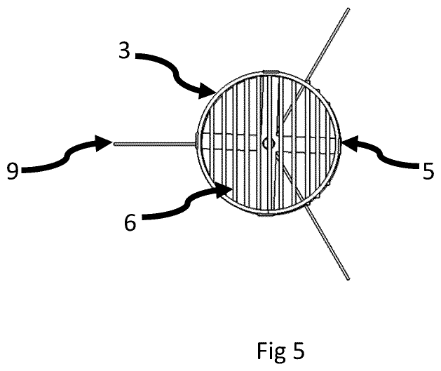

### DETAILED DESCRIPTION

The description of embodiments cited herein provides clarification to the present disclosure and, constitute a part of the present disclosure, and is not intended to limit the scope of the present disclosure.

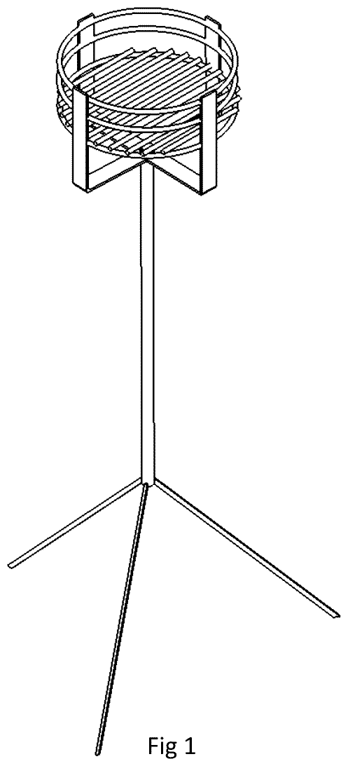

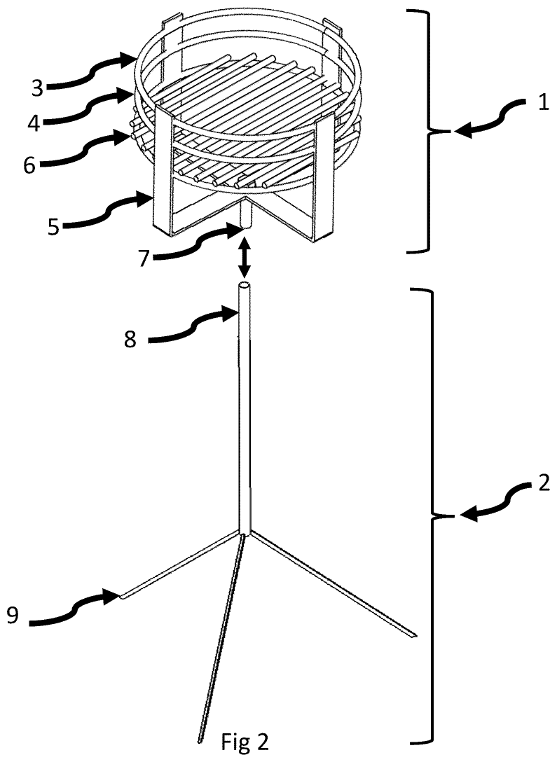

A physical description of the portable microplastic filter stand is that it is completely made out of non-plastic components, including but not limited to metal chrome plating or stainless steel. The general shape is vertical orientation with a raised flat surface, similar to a small table when fully assembled (FIG. 1). To be portable, there are two main components: Top table platform surface (1) and Bottom post and legs (2) (FIG. 2). These components can be separated and fit together using gravity to hold or any other fastening methods. An example of this type of connection is facilitated through the use of a bolt protruding from the Top (1) and fitting into a similarly sized receiver in the Bottom (2) so that when they are joined, the protruding bolt is fully seated into the Bottom (2) and held in place by constraint and by gravity (FIG. 2). The Top (1) is comprised of two guardrails (3) & (4), which can be spot welded or mechanically fastened to the holding bracket (5) (FIG. 2). The flat surface (6) is made from parallel metal rods fixed to a frame to provide a flat-level surface with open air (FIG. 2). The flat surface (6) can be spot welded or mechanically fastened to the holding bracket (5) (FIG. 2). Therefore, the two guardrails (3) & (4), the holding bracket (5), and the flat surface (6) are joined components that make a bowl-like design (FIG. 2). The micron filter (10) is placed on top of the flat surface (6) and prevented from falling off through contact with the guardrails (3) & (4) and holding bracket (5) (FIG. 2). The bottom of the holding bracket (5) is connected to a bolt (7), which protrudes from the bottom of the holding bracket (5) (FIG. 2). The protruding end of the bolt (7) provides a connection point for the Top (1) and the Bottom (2), where the bolt (7) fits into the opening at the top of the post (8) (FIG. 2). The post (8) is connected to fixed legs (9) (FIG. 2). The legs (9) extend out from the post (8) to provide stability for the portable microplastic filter stand to stand vertically (FIG. 2).

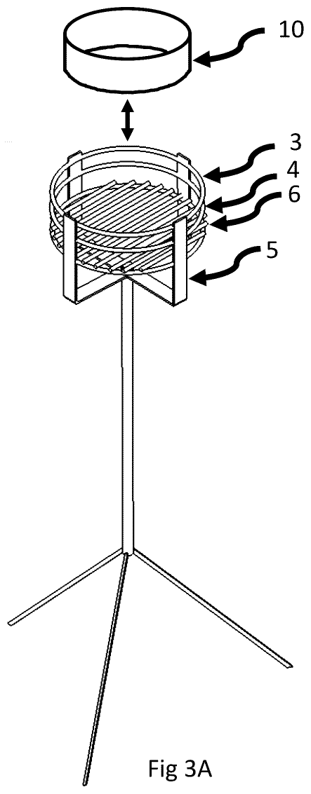

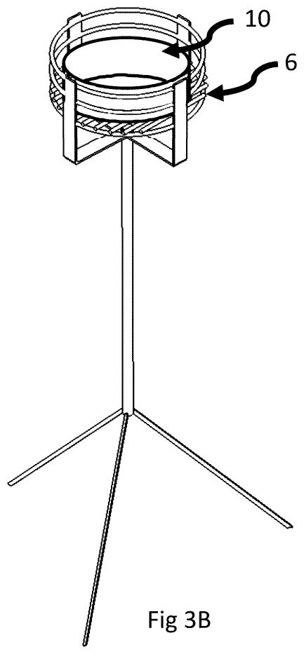

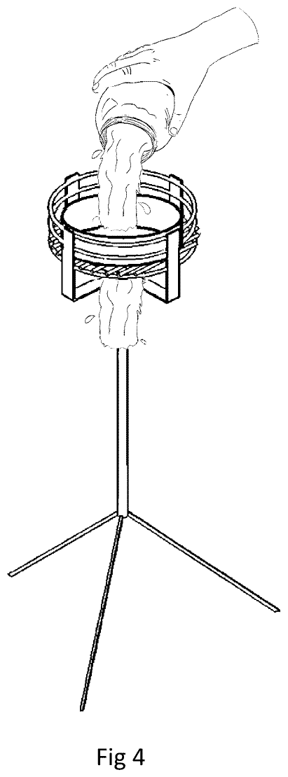

An operational description of how the portable microplastic filter stand works includes transporting the device to the desired location at a water source. The Bottom (2) is placed in the water source so that it stands independently, and the top is above the surface of the water (FIG. 2). Assemble the Top (1) by joining it to the Bottom (2) by fitting the bolt (7) into the top of the post (8) (FIG. 2). Adjust the placement of the Bottom (2) as it stands in the water source so that the flat surface (6) is flat or approximately level (FIG. 2). Place the micron filter (10) onto the top of the flat surface (6) (FIG. 3A and FIG. 3B). The portable microplastic filter stand top (1) holds the micron filter (10) as water is poured through the micron filter (10) and passes through the top of the device (FIG. 3B and FIG. 4). The water is returned to the water source through gravity and any filtered microplastics will be in the micron filter (10) (FIG. 3B).

1. A stand apparatus for holding microplastic filters comprising: a top having a table platform surface and a bottom having a post and legs.

2. A stand apparatus as in claim 1: wherein said top supports a micron filter or mesh sieve.

3. A stand apparatus as in claim 1: wherein said top having guardrails that constrains a micron filter or mesh sieve to said top.

4. A stand apparatus as in claim 1, wherein said stand apparatus can be used in water outdoors.

5. A stand apparatus as in claim 1, wherein said stand apparatus can stand independently.

6. A stand apparatus as in claim 1, wherein said top can elevate said micron filter or mesh sieve above water.

7. A stand apparatus as in claim 1, wherein said top has a maximum allowable flow rate larger than said micron filter or mesh sieve.

8. A stand apparatus as in claim 1, wherein said top can be fastened to connect and unfastened to disconnect from said bottom.

9. A stand apparatus as in claim 1, wherein said top can be separated from said bottom.

10. A stand apparatus as in claim 1, wherein said top can be carried by an average person.

11. A stand apparatus as in claim 1, wherein said bottom can be carried by an average person.

12. A stand apparatus as in claim 1, wherein said stand apparatus is only comprised of metal material.
